(19) United States
(12) Patent Application Publication
(10) Pub. No.: US 2002/0003878 A1
(43) Pub. Date: Jan. 10, 2002

(54) Cryptographic key distribution system and method for digital video systems

(76) Inventors: Erlend Olson, Duarte, CA (US); David Rogoff, Irvine, CA (US); Steven Petilli, Pasadena, CA (US); Oleh Zajac, Arcadia, CA (US)

Correspondence Address: CHRISTIE, PARKER & HALE, LLP, P.O. BOX 7068, PASADENA, CA, 91109-7068, US

(21) Appl. No.: 09/844,898

(22) Filed: Apr. 27, 2001

Related U.S. Application Data
(60) Provisional application No. 60/200,194, filed on Apr. 28, 2000.

(51) Int. Cl. H04L 9/00; G06F 12/14

(52) U.S. Cl. 380/201; 380/278; 713/193

(57) ABSTRACT

A system and method for distribution of cryptographic keys to data encryption and decryption devices used to protect digital video/multimedia data transmitted over a display link between a digital video/multimedia source and a display device are provided. The digital data from a digital video/multimedia source, such as, for example, a Digital Versatile Disk (DVD) player, is encrypted prior to transmission on the display link. The encrypted digital video/multimedia data is received from the display link transmitter, decrypted and sent to a display device. Secure digital data input lines are used to load cryptographic keys into RAM on the same integrated circuit as the encryption device. A public key system is used to cipher the video decryption keys, so that the decryption keys can be sent to the display link receiver. Use of key management and storage that are external to the data encryption or decryption devices enables downloading of new keys from external key sources.

### CROSS-REFERENCE TO RELATED APPLICATION

The present application claims the priority of U.S. Provisional application Ser. No. 60/200,194 entitled “Cryptographic Key Distribution System and Method for Digital Video Systems” filed Apr. 28, 2000, the contents of which are fully incorporated by reference herein.

### FIELD OF THE INVENTION

The present invention relates to a system and method for distributing cryptographic keys to digital data encryption and decryption devices, and particularly to the distribution of cryptographic keys for digital video and/or multimedia systems.

### BACKGROUND OF THE INVENTION

The use of digital technology continues to make rapid advances in many fields, and the digital technology is increasingly being applied to areas that once were completely relegated to the analog domain. One such area is distribution of motion pictures, which are increasingly being digitized and sold on DVDs (Digital Versatile Disks). The low cost and high quality afforded by the DVDs have led to a boom in the sale of DVD players and DVDs.

There is a great deal of concern among the content producers, e.g., the movie studios, about the release of motion pictures in digital formats. The content producers are particularly concerned about the next generation of DVDs, which will carry high definition video images. For example, a consumer can buy a DVD and duplicate it illegally without any loss in video quality, if he can access the digital video signals. In order to prevent easy access to the digital video signals, most DVD players on the market today provide video output in analog format only.

DVDs containing high definition video images of motion pictures may not be available for sale unless the data on the DVDs can be protected from copying, both while on the disk and during its routing to a display device. Therefore, before consumer type DVD players with digital video outputs are available for sale, the content producers and DVD player manufacturers preferably should agree on a secure way of sending digital video data from the DVD players to video display monitors or televisions.

The digital video data is typically in parallel format and is converted to serial format (for digital video output) by a digital transmitter before being sent out on a digital display link to a video monitor or a television. On the display side, a digital receiver converts the serial data back into parallel format. The digital signal on the display link cable, if not protected, e.g., via encryption, can be intercepted and copied by a person wanting to steal the digital video data.

There is a standard digital display link for connecting a digital video signal from a computer to a display monitor, which is known as Digital Visual Interface (DVI). There is also a proposed standard for the content protection of such display links, known as High-bandwidth Digital Content Protection (HDCP), which provides for the encryption of digital video data between a digital video source and a display monitor using cryptographic keys. Both the digital video source and the display monitor should preferably have access to the cryptographic keys to encrypt and decrypt, respectively, the digital video data.

Therefore, it is desirable to provide an improved system and method for loading of the cryptographic keys to a digital video data encryptor on the digital video source side and the decryptor on the display monitor side.

### SUMMARY OF THE INVENTION

In one embodiment of the present invention, a system for distributing cryptographic keys for encrypting digital data is provided. A first key storage medium is used for storing a cryptographic key. A digital data input medium is used for receiving digital data to be encrypted. A selector is used for coupling the first key storage medium to a second key storage medium via the digital data input medium. The second key storage medium is used to store the cryptographic key temporarily before the cryptographic key is used for encrypting the digital data.

In another embodiment of the present invention, a method for distributing an encryption key for encrypting digital data is provided. An encryption key is selected from a first set of encryption keys stored in a first storage medium. The selected encryption key is transferred from the first storage medium to a second storage medium over a digital data transfer medium that is also used for transferring the digital data to be encrypted. The selected encryption key is stored temporarily in the second storage medium until it is used by an encryptor to encrypt the digital data.

In yet another embodiment of the present invention, a system for encrypting digital data is provided. A first input terminal is used for receiving the digital data. A second input terminal is used for receiving a key. An encryptor is used for receiving and encrypting the digital data using the key. A first output terminal is used for transmitting the encrypted digital data. The system receives the key via the second input terminal during operation of the system from an external key storage medium.

In still another embodiment of the present invention, a method of encrypting digital data in a data encryption system is provided. The digital data is received. A key is received from an external key storage medium. The digital data is encrypted using the key. The encrypted digital data is transmitted as an output. The digital data and the key are received during operation of the data encryption system.

In a further embodiment of the present invention, a system for distributing cryptographic keys from a digital data transmitter to a digital data receiver via a digital link is provided. The system includes a digital data transmitter and a digital data receiver. The digital data transmitter includes a first key storage medium for storing a first encryption key, a second encryption key and a first decryption key. The digital data transmitter also includes a data encryptor for using the first encryption key to encrypt digital data, and for using the second encryption key to encrypt the first decryption key. Further, the digital data transmitter includes a data link transmitter system for transmitting the encrypted digital data and the encrypted first decryption key over the digital link. The digital data receiver includes a data link receiver, a second key storage medium, a data decryptor and a third key storage medium. The data link receiver receives the encrypted digital data and the encrypted first decryption key over the digital link. The second key storage medium stores a second decryption key. The data decryptor uses the second decryptor key to decrypt the encrypted first decryption key, and uses the first decryption key to decrypt the encrypted digital data. The third key storage medium is used to store the first decryption key.

These and other advantages of the present invention will become apparent from the following detailed description and the drawings.

### BRIEF DESCRIPTION OF THE DRAWINGS

FIG. 1 is a block diagram of a digital display link system according to an embodiment of the present invention;

FIG. 2 is a block diagram of a cryptographic key distribution system;

FIG. 3 is a block diagram of a cryptographic key distribution system for a digital display link transmitter in an embodiment according to the present invention;

FIG. 4 is a general flowchart of overall operations involved in the process of loading cryptographic keys into an encryptor in an embodiment according to the present invention;

FIG. 5 is a block diagram of an encryption system within a DVD player in an embodiment according to the present invention; and

FIG. 6 is a block diagram of a digital display link receiver including a decryptor in an embodiment according to the present invention.

### DETAILED DESCRIPTION

One embodiment of the present invention improves upon previous attempts to manage the distribution of cryptographic keys to digital video data encryptors and decryptors. One approach to the distribution of cryptographic keys has been to load the keys into a ROM (Read Only Memory) chip which is physically next to the data encryptor and on the same circuit board. If each cryptographic key is unique to the system it is used in, then each ROM has to be specifically programmed during manufacture of the system. In the conventional art, a dedicated connection between the external ROM chip and the data encryptor has been provided.

Instead of using the ROM chip adjacent to the data encryptor to store the keys, one embodiment of the present invention uses RAM (Random Access Memory) on the same integrated circuit as the data encryptor. In one embodiment of the present invention, incoming digital video signal connections to the data encryptor integrated circuit is used to transmit cryptographic keys to the RAM. In other embodiments, other connections, such as, for example, an I²C control bus may be used to transmit the cryptographic keys to the RAM.

Thus, these embodiments of the present invention may not require any additional pins or electrical connections to be made to the data encryptor. Given the increasing complexity of today's integrated circuits and the increasing number of pins needed for external connections, eliminating even a few extra pins may be important to meet IC (integrated circuit) design goals.

On the display side of a digital display link, a cryptographic decryptor stores the cryptographic keys needed for decoding an encrypted data stream. Similar to the case of the encryptor, the cryptographic keys conventionally have been stored in an adjacent ROM chip. In an embodiment according to the present invention, the decryptor stores the decoding keys in RAM, instead of on the ROM chip. In other embodiments, the cryptographic keys may be loaded directly to the encryptor (e.g., a register on the encryptor) without being stored in memory (e.g., RAM or ROM) first.

In this embodiment of the present invention, the cryptographic keys preferably are encrypted and then sent from a transmitter to a receiver over the display link. In this embodiment, all key storage preferably is managed from the transmitter. In another embodiment according to the present invention, the cryptographic keys are not stored permanently in the source video system, but can be downloaded from another source, such as a set-top box.

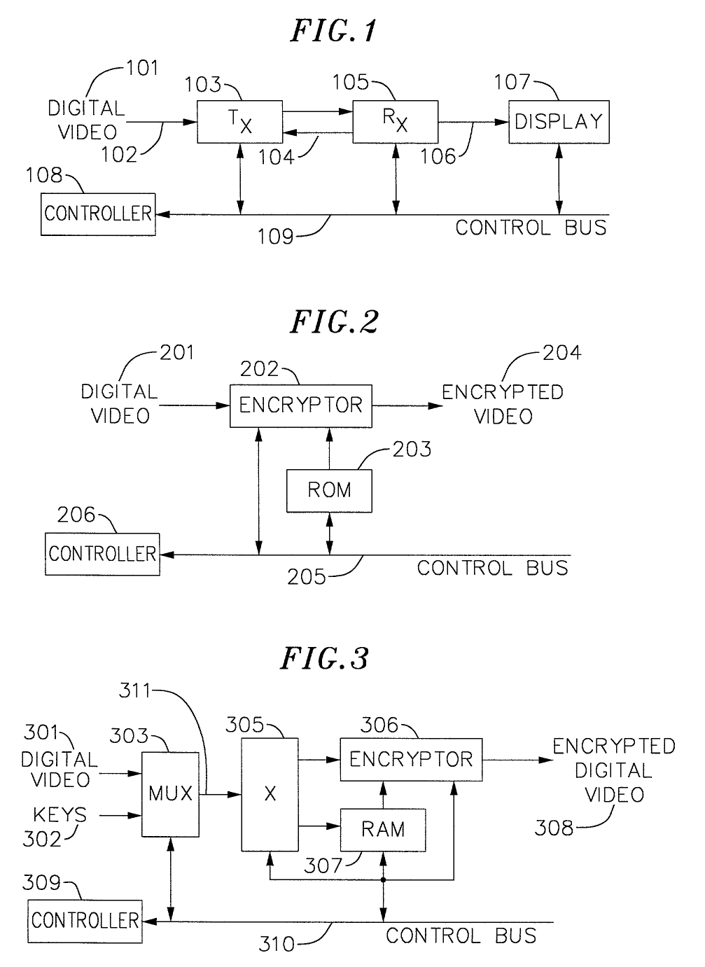

Referring now to FIG. 1, a block diagram of a digital display link system according to an embodiment of the present invention is illustrated. A digital video source 101 is coupled to a transmitter 103 via input lines 102. Among other processing performed by the transmitter 103, digital video data from the digital video source 101 preferably is encrypted for transmission on digital display link 104. The digital video source 101 may also provide other data, such as, for example, multimedia data and/or cryptographic keys for encryption of the digital video/multimedia data. The multimedia data may include one or more of, but is not limited to, video, audio, web contents, graphics and text.

On the display side of the system, a receiver 105, among other processing operations, preferably decrypts the encrypted digital video/multimedia signal received over the digital display link 104 and produces a digital video signal, which is sent on output lines 106 to a display 107. The digital display link 104 may also be used to send decryption keys to the receiver 105 for decrypting the received encrypted digital video/multimedia signal. The overall operation of the system may be controlled by a controller 108 using a control bus 109. The controller 108 may include a finite state machine (FSM) , a microprocessor, a micro controller and/or any other suitable device for controlling the overall operation of the system.

The digital display link 104 from the transmitter 103 to the receiver 105 may include a bi-directional signal path. The bi-directional signal path may be useful when, for example, there is a video camera at the display end sending video signals back to the video source end for distribution and/or processing.

The input lines 102 coupled to the transmitter 103 and the output lines 106 coupled to the receiver 105 should be physically secured to protect the digital video data on them. Thus, these input and output lines are usually within separate physical enclosures. On the other hand, the digital display link 104 includes a cable between the video source and a display, and the data flowing through the cable should be protected via encryption to prevent it from being copied illegally.

FIG. 2 is a block diagram of a cryptographic key distribution system. Incoming digital video signals 201 are encrypted by an encryptor 202 according to the cryptographic keys stored in ROM 203. The ROM 203, for example, may be implemented on a separate IC chip. The encryptor 202 produces an encrypted video signal 204. Key loading and encryption are controlled by controller 206, which uses a control bus 205.

There are several limitations to the system in FIG. 2. One is that it permanently stores the encryption keys in the ROM 203 adjacent to the encryptor 202. Having the keys permanently stored on a separate integrated circuit on the circuit board makes the keys susceptible to being stolen and/or bypassed. Another difficulty is that the keys stored in a ROM cannot be changed. It would be useful to have a capability to change keys if the keys originally loaded in the equipment are compromised and need to be replaced.

The connection between the encryptor 202 and the ROM 203 may require additional pins on the encryptor package. This may be difficult to provide, especially if the encryptor 202 is a part of a larger system on a chip (SOC), which typically already has many pins with none to spare.

FIG. 3 is a block diagram of a cryptographic key distribution system for a digital display link transmitter. In the system of FIG. 3, incoming digital video signals 301 are coupled to an encryptor 306 via a multiplexer 303, incoming data lines 311 and a selector switch 305. The incoming digital video signals 301 may also include multimedia signals and/or other data. The multimedia signals may include one or more of, but is not limited to, video, audio, web contents, graphics and text. The encryptor 306 preferably has a video port, which may also be referred to as a pixel port or data port, for receiving the incoming digital video signals from the selector switch 305. The encryptor 306 preferably encrypts the digital video signals 301 to produce encrypted digital video signals 308. The encrypted digital video signals 308 may also include encrypted multimedia signals and/or encrypted data.

The encryptor 306 preferably should have secure input connections (i.e., incoming data lines 311), so as to prevent the digital video signals 301, which are not encrypted, from being intercepted and/or copied. Because of the secure connections to the encryptor 306, encryption keys 302, which may also be referred to as cryptographic keys or keys, may be loaded into the encryptor 306 on the incoming data lines 311. In one embodiment of the present invention, the encryption keys preferably are loaded in RAM 307 prior to being loaded in the encryptor 306. The RAM 307 in other embodiments may be replaced by another suitable storage medium. The encryption keys are then loaded to the encryptor 306 via a key port of the encryptor. If the encryptor 306 and the RAM 307 are fabricated on the same IC chip and the incoming data lines 311 are used to input the encryption keys, there is no need for extra package pins on the display link transmitter.

Hence, prior to the start of encryption, the encryption keys 302 preferably are loaded via the multiplexer 303 onto the incoming data lines 311 to be stored in the RAM 307. The incoming data lines 311 are coupled to the RAM 307 via the selector switch 305 which selects between the encryptor 306 (e.g., for the digital video signals 301) and the RAM 307 (e.g., for the encryption keys 302). The keys stored in the RAM 307 preferably are then loaded into the encryptor 306 via the key port for encryption of the digital video signals 301.

The encryption keys loaded into the RAM 307 typically are stored there temporarily and may be reloaded as needed from internal or external sources, such as a software program, an encrypted DVD, a smart card, a set-top box, a cable modem or any other suitable key source. The encryption keys may also be stored in a ROM or PROM module within another system chip upstream of the encryptor system.

The operation of the system in FIG. 3 preferably is controlled by a controller 309 using a control bus 310. The control bus 310, for example, may include an I²C control bus or any other suitable control bus. The controller, for example, may include a finite state machine (FSM), a microprocessor, a micro controller, an ASIC or any other suitable device for controlling traffic on the control bus 310.

In other embodiments, the encryption keys may be loaded directly onto a register in the encryptor 306 and not stored in the RAM 307 or any other memory. In still other embodiments, the encryption keys may be loaded to either the RAM 307 or the encryptor 306 via the control bus 310, which may be an I²C control bus. In this case, since the encryption keys 302 do not have to share the incoming data lines 311 with the digital video signals 301, the multiplexer 303 and/or the selector switch 305 may not be needed.

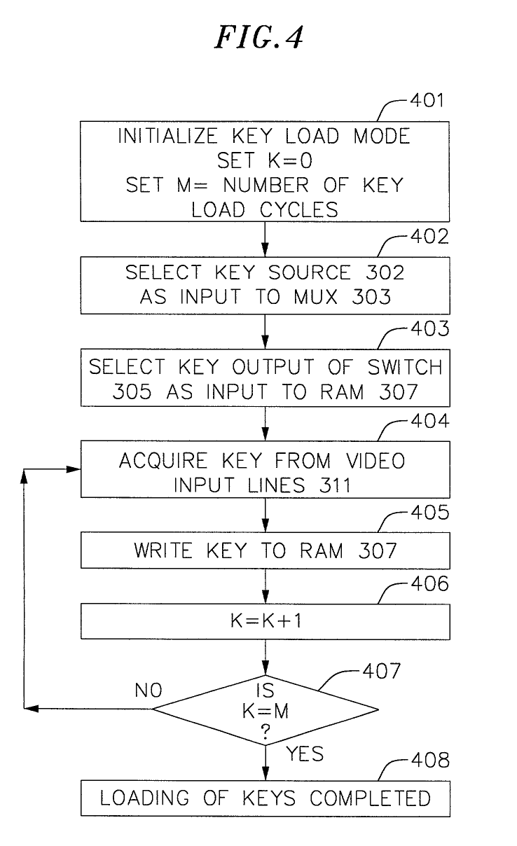

FIG. 4 is a general flowchart of operations in the process of loading cryptographic keys into an encryptor, such as, for example, the encryptor 306 of FIG. 3. The loading of the cryptographic keys is initialized in step 401 and a counter K is reset to zero. The counter K preferably keeps track of the number of times a different key or segment of a key has been loaded into RAM, such as, for example, the RAM 307 of FIG. 3. For example, loading of different keys or key segments are used in situations when more than one key is required for encryption or when a key is split into segments because the key is too long to be loaded in one load cycle.

If video input lines, such as, for example, the incoming data lines 311 of FIG. 3, carry a composite video RGB signal, there are three channels of data. If the data on the video input lines is in a parallel format and each data element is a byte, then the video input lines include 24 parallel data lines within. This allows a 24-bit key or segment of a key to be input into the encryptor during a single key load cycle. If a key is part of a set of keys, then multiple load cycles may be needed to load all of the keys. A variable M is set during step 401 to the number of load cycles needed to load all the keys or key segments needed by the encryptor.

In step 402, a key source, which contains keys, such as, for example, the encryption keys 302 of FIG. 3, preferably is selected as input to a multiplexer, such as, for example, the multiplexer 303 of FIG. 3. In step 403, a key output of a switch, such as, for example, the switch 305 of FIG. 3, preferably is selected as input to the RAM. Selecting these two paths provides a path from key source 302 to RAM 307.

In step 404, a key or key segment from the key source preferably is acquired via the video input lines. In step 405, the acquired key preferably is loaded into the RAM. In step 406, the counter K, which is equal to the number of load cycles performed, preferably is incremented by 1.

In step 407, the counter K preferably is compared to M, where M is the number of load cycles needed to load all the needed keys. If the counter K is equal to M, then the loading of the keys has been completed as indicated in step 408. If the counter K is less than M, then steps 404, 405 and 406 preferably are repeated to acquire the next key or key segment, and the counter K, after being incremented by 1, is compared once again with M. Hence, steps 404, 405, 406 and 407 are repeated in a loop until all the keys or key segments are loaded.

FIG. 5 is a block diagram of an encryption system within a DVD player in an embodiment according to the present invention. DVD data 501 from a DVD reader is input to a DVD data decoder 502. The DVD data 501 may include video data and/or multimedia data. The DVD data 501 may also include other data, such as, for example, graphics or closed caption information. The DVD data decoder 502 preferably decodes the DVD data 501 to generate digital video, multimedia and/or other data. A multiplexer 504 couples either the digital video from the DVD data decoder 502 or cryptographic keys from a key source 503 to a selector switch 510. The key source 503 may include any suitable storage medium for storing the cryptographic keys.

The selector switch 510 preferably provides the digital video, multimedia and/or other data for encryption to the encryptor 505 via a video port, which may also be referred to as a pixel port or a data port. The selector switch 510 preferably also provides the cryptographic keys to the encryptor 505 via a key port. The encryptor 506 preferably contains a register for storing the received cryptographic keys.

In other embodiments, the key source 503 may provide the cryptographic keys to a RAM external to the encryptor 505 via the multiplexer 504 and the selector switch 510 and not directly to the key port on the encryptor 505. In this case, the cryptographic keys may be stored in the RAM temporarily, and then loaded onto the register in the encryptor 505 via the key port as needed for encryption of the digital video, multimedia, and/or other data. The RAM may be implemented on the same integrated circuit chip as the encryptor 505.

After the encryption, the encrypted digital video, as well as the encrypted multimedia and/or other encrypted data, preferably is sent to a display link transmitter 506, which provides an output signal suitable for transmission over display link 507. The encrypted digital video, multimedia and/or other data preferably are encrypted in such a way that interception and/or decryption of the digital video, multimedia and/or other data preferably is prevented.

The operation of the system in FIG. 5 preferably is controlled by a controller 508 using a control bus 509. The control bus 509, for example, may include an I²C control bus or any other suitable control bus. The controller, for example, may include a finite state machine (FSM), a microprocessor, a micro controller, an ASIC or any other suitable device for controlling traffic on the control bus 509.

In other embodiments, the cryptographic keys may be loaded to either the RAM or directly to the encryptor 505 via the control bus 509, which may be an I²C control bus. In this case, since the cryptographic keys from the key source 503 do not have to share incoming data lines from the multiplexer 504 with the digital video, multimedia and/or other data, the multiplexer 504 and/or the selector switch 510 may not be needed.

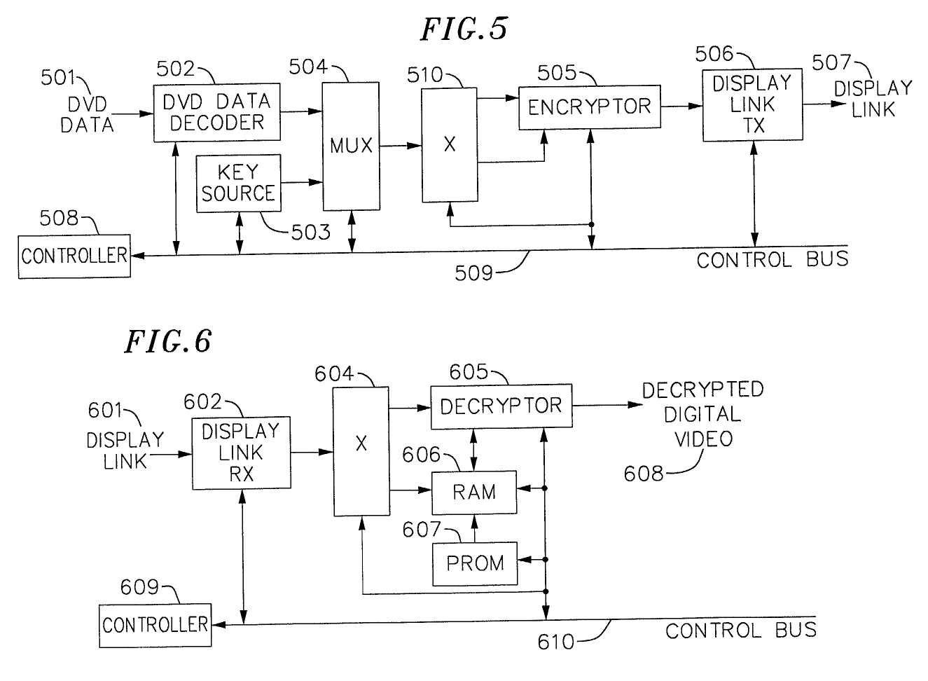

The encryptor 505 may also encode video decryption keys and transmit over the display link to a digital display link receiver to be used for decryption of the encrypted digital video, multimedia and/or other data at the receiver side (e.g., display side). The encoded video decryption keys are decoded at the receiver side prior to the decryption of the encrypted digital video, multimedia and/or other data. The encoding and decoding of the cryptographic keys are described further in reference to FIG. 6.

FIG. 6 is a block diagram of a digital display link receiver including a decryptor 605 in an embodiment according to the present invention. Incoming serial data preferably arrives over a display link 601. The incoming serial data preferably includes encrypted digital video, multimedia and/or other data, and may have been transmitted over the display link 507 of FIG. 5.

During normal operation, the incoming serial data preferably is received by a display link receiver 602. The display link receiver 602 preferably converts the incoming serial data into a video data in parallel format and sends the parallel video data to the decryptor 605 via a switch 604. The display link receiver 602 may also extract multimedia and/or other data from the incoming serial data, and send to the decryptor 605 for decryption. The decryptor 605 preferably generates decrypted digital video 608, which may include decrypted multimedia and/or decrypted data, and sends it via physically secure internal wiring to a video display or monitor.

The operation of the system in FIG. 6 preferably is controlled by a controller 609 using a control bus 610. The control bus 610, for example, may include an I²C control bus or any other suitable control bus. The controller, for example, may include a finite state machine (FSM), a microprocessor, a micro controller, an ASIC or any other suitable device for controlling traffic on the control bus 610.

Prior to the start of decryption of the encrypted digital video, multimedia and/or other data, a public key system is used to cipher the video decryption keys, so that they can be sent via the digital display link to the decryptor 605. A public key preferably is loaded from a key source, such as, for example, the key source 503 of FIG. 5, into an encryptor, such as, for example the encryptor 505. A corresponding private key preferably is loaded from PROM 607 into RAM 606. The private key is used to decipher the video decryption keys sent from the display link transmitter in FIG. 5. The video decryption keys needed by the decryptor 605 preferably are provided by the key source and encrypted by the encryptor, and sent to the display link receiver in FIG. 6 during a startup procedure. In other embodiments, the private key may be loaded directly to a decryptor register from the PROM 607 via a key port of the decryptor 605 without being stored temporarily in RAM.

Public key cryptography is well known to those skilled in the art and the public key cryptography used in this embodiment is one example of the use of public key cryptography to protect the transmission of decryption keys to the receiver. In other embodiments, other cryptographic systems may be used to protect the keys during transmission to the receiver. For example, in one embodiment of the present invention DES (Data Encryption Standard) encoding and decoding may be used to encode and decode keys.

The display link receiver in FIG. 6 receives the ciphered video decryption keys on the display link 601. The ciphered video decryption keys are extracted by the display link receiver 602. The ciphered video decryption keys are input to the decryptor 605, which uses the private key stored in the PROM 607 to decipher the video decryption keys, which are then stored in the RAM 606. Once the RAM 606 has all the keys needed for video decryption, then the display link receiver is ready to start decrypting the encrypted video data sent by a display link transmitter, such as, for example, the display link transmitter 506 of FIG. 5.

The following list of events provides an overview of the initialization process performed at startup to load video decryption keys into the display link receiver:

Steps 2 to 6 take place in the display link transmitter. Steps 1, 7 to 9, 11 take place in the display link receiver:

1. Load private key from the PROM 607 into the RAM 606.

2. Load public key from the key source 503 into the encryptor 505.

3. Load video decryption key from the key source 503 as data into the encryptor 505.

4. Cipher the video decryption key using the public key loaded in the encryptor 505.

5. Send the ciphered video decryption key to the display link transmitter 506.

6. Transmit the ciphered video decryption key via the display link 507.

7. Receive the ciphered video decryption key at the display link receiver 602.

8. Decipher the ciphered video decryption key received from the display link transmitter 506 using private key from the PROM 607.

9. Load the video decryption key into the RAM 606.

10. Repeat steps 3 to 9 until all video decryption key segments or video decryption keys have been loaded into the RAM 606.

11. Load the video decryption keys from the RAM 606 into the decryptor 605.

12. Ready to start decrypting encrypted digital video.

Although this invention has been described in certain specific embodiments, many additional modifications and variations would be apparent to those skilled in the art. It is therefore to be understood that this invention may be practiced otherwise than as specifically described. Thus, the present embodiments of the invention should be considered in all respects as illustrative and not restrictive, the scope of the invention to be determined by the appended claims and their equivalents.

We claim:

1. A system for distributing cryptographic keys for encrypting digital data, the system comprising:
a first memory for storing a cryptographic key;
a digital data input medium for receiving digital data to be encrypted;
a second memory; and
a selector for coupling the first memory to the second memory via the digital data input medium,
wherein the second memory is used to store the cryptographic key temporarily before the cryptographic key is used for encrypting the digital data.

2. The system according to claim 1, wherein the digital data comprises digital video data.

3. The system according to claim 2, wherein the digital video data is in composite RGB format.

4. The system according to claim 1, wherein the digital data comprises multimedia data.

5. The system according to claim 1, wherein the digital data is encrypted in accordance with the High-bandwidth Digital Content Protection specification.

6. The system according to claim 1, wherein the second memory and the selector are implemented on a single integrated circuit chip.

7. A method for distributing an encryption key for encrypting digital data, the method comprising:
selecting an encryption key from a first set of encryption keys stored in a first memory;
transferring the selected encryption key from the first memory to a second memory over a digital data transfer medium that is also used for transferring the digital data to be encrypted; and
storing the selected encryption key temporarily in the second memory until it is used by an encryptor to encrypt the digital data.

8. The method according to claim 7, wherein the digital data comprises digital video data.

9. The method according to claim 8, wherein the digital video data is in composite RGB format.

10. The method according to claim 8, wherein the digital data comprises multimedia data.

11. The method according to claim 7, wherein the first set of encryption keys includes keys compatible with the High-bandwidth Digital Content Protection specification.

12. A system for encrypting digital data, the system comprising:
a first input terminal for receiving the digital data;
a second input terminal for receiving a key;
an encryptor for receiving and encrypting the digital data using the key; and
a first output terminal for transmitting the encrypted digital data,
wherein the system receives the key from an external key storage medium via the second input terminal during operation of the system.

13. The system for encrypting digital data according to claim 12, the system further comprising random access memory (RAM) for storing the key before the key provided to the encryptor to be used for encryption of the digital data.

14. The system for encrypting digital data according to claim 13, the system further comprising a multiplexer coupled to the first input terminal and the second input terminal, wherein the multiplexer outputs either the digital data from the first input terminal or the key from the second input terminal.

15. The system for encrypting digital data according to claim 14, the system further comprising a selector switch for receiving the digital data and the key from the multiplexer, wherein the selector switch provides the digital data to the encryptor, and wherein the selector switch provides the key to the RAM.

16. The system for encrypting digital data according to claim 12, wherein the key includes an encryption key, which is used for encrypting the digital data.

17. The system for encrypting digital data according to claim 12, wherein the second input terminal receives the key as a plurality of key segments.

18. The system for encrypting digital data according to claim 12, wherein the key includes a decryption key, which is used for decrypting the encrypted digital data.

19. The system for encrypting digital data according to claim 18, wherein the first output terminal is used to transmit the decryption key.

20. The system for encrypting digital data according to claim 19, wherein the decryption key is encoded prior to being transmitted via the first output terminal.

21. The system for encrypting digital data according to claim 20, wherein the key includes an encoding key, and the encoding key is used to encode the decryption key in the encryptor before the decryption key is transmitted via the first output terminal.

22. The system for encrypting digital data according to claim 12, wherein the digital data comprises digital video data.

23. The system for encrypting digital data according to claim 22, wherein the digital video data is in composite RGB format.

24. The system for encrypting digital data according to claim 12, wherein the digital data comprises multimedia data.

25. The system for encrypting digital data according to claim 12, wherein the encryptor complies with the requirements of the High-bandwidth Digital Content Protection (HDCP) specification.

26. The system for encrypting digital data according to claim 12, wherein the first input terminal, the second input terminal, the encryptor and the first output terminal are implemented on a single integrated circuit (IC) chip.

27. The system for encrypting digital data according to claim 12, wherein the second input terminal comprises a control bus, and wherein the system further comprises a controller coupled to the control bus, wherein the controller controls data flow in the system.

28. The system of encrypting digital data according to claim 27, wherein the control bus comprises an I²C bus.

29. The system of encrypting digital data according to claim 27, wherein the controller is selected from a group consisting of a finite state machine (FSM), a microprocessor and a micro controller.

30. A method of encrypting digital data in a data encryption system, the method comprising the steps of:
receiving the digital data;
receiving a key from an external key storage medium;
encrypting the digital data using the key; and
transmitting the encrypted digital data as an output,
wherein the steps of receiving the digital data and receiving the key are performed during operation of the data encryption system.

31. The method according to claim 30, the method further comprising the step of storing the key in random access memory (RAM) before the key is used for encryption of the digital data.

32. The method according to claim 30, wherein the key includes an encryption key, and the encryption key is used for encrypting the digital data.

33. The method according to claim 30, wherein the step of receiving the key comprises the step of receiving a plurality of key segments.

34. The method according to claim 30, wherein the key includes a decryption key, and the decryption key is used for decrypting the encrypted digital data.

35. The method according to claim 34, the method further comprising the step of transmitting the decryption key.

36. The method according to claim 35, the method further comprising the step of encoding the decryption key before it is transmitted.

37. The method according to claim 36, wherein the key includes an encoding key, and the encoding key is used to encode the decryption key before the decryption key is transmitted as the output.

38. The method according to claim 30, wherein the digital data comprises digital video data.

39. The method according to claim 38, wherein the digital video data is in composite RGB format.

40. The method according to claim 30, wherein the digital data comprises multimedia data.

41. The method according to claim 30, wherein the step of encrypting the digital data complies with the requirements of the High-bandwidth Digital Content Protection (HDCP) specification.

42. A system for distributing cryptographic keys from a digital data transmitter to a digital data receiver via a digital link, the system comprising:
a digital data transmitter comprising
a first key storage medium for storing a first encryption key, a second encryption key and a first decryption key;
a data encryptor for using the first encryption key to encrypt digital data, and for using the second encryption key to encrypt the first decryption key; and
a data link transmitter system for transmitting the encrypted digital data and the encrypted first decryption key over the digital link; and
a digital data receiver comprising:
a data link receiver for receiving the encrypted digital data and the encrypted first decryption key over the digital link;
a second key storage medium for storing a second decryption key;
a data decryptor for using the second decryptor key to decrypt the encrypted first decryption key, and for using the first decryption key to decrypt the encrypted digital data; and
a third key storage medium for storing the first decryption key.

43. The system according to claim 42, wherein the digital data transmitter comprises a Digital Versatile Disk (DVD) player.

44. The system according to claim 42, wherein the digital data comprises digital video data.

45. The system according to claim 42, wherein the digital data comprises multimedia data.

46. The system according to claim 42, wherein the second encryption key comprises a public key and the second decryption key comprises a private key.
